(19) United States
(12) Patent Application Publication
(10) Pub. No.: US 2008/0145045 A1
(43) Pub. Date: Jun. 19, 2008

(54) Method of group guiding service in sensor networks and system using the same

(75) Inventors: Po-Yu Chen, Kaohsiung County (TW); Chi-Fu Huang, Hsinchu City (TW); Yu-Chee Tseng, Hsinchu City (TW); Wen-Tsuen Chen, Kaohsiung County (TW)

Correspondence Address: BUCKNAM AND ARCHER, 1077 NORTHERN BOULEVARD, ROSLYN, NY, 11576, US

(73) Assignee: National Tsing Hua University

(21) Appl. No.: 11/732,091

(22) Filed: Apr. 2, 2007

(30) Foreign Application Priority Data
Dec. 4, 2006 (TW) 095144961

(51) Int. Cl. G03B 1/00

(52) U.S. Cl. 396/411

(57) ABSTRACT

A method of group guiding service in wireless sensor networks and a system using the same are disclosed in this invention. According to this invention, wireless sensor networks may be utilized to track the position of the group leader and provide leader information and guiding services to the group members. The location of every group leader is able to be traced by the sensor network in accordance with a leader device and the technology of wireless communication. In addition, a multifunctional guiding director and the RFID system are also utilized in this invention.

### FIELD OF THE INVENTION

The present invention relates to a guiding method and system, and more particularly to a method for providing group guiding service using wireless sensor networks and a system using the same.

### BACKGROUND OF THE INVENTION

As shown in FIG. 1, there are often one or more groups visiting in an exhibition environment such as an ordinary museum or an art museum. The group members (Followers) 111, 112 are usually led by a tour guide (Leader) 110, 120 in each group. While visiting such places, members do not always follow their leaders 110, 120. Due to the differences in personal preferences, the group members may scatter in the exhibition area. The museums are usually broad and the group members 111, 121 may not be familiar with such environment, thus it may not be easy for them to find their tour guide 110, 120 or the correct path, and they may easily get lost, like the group member 111A or 121A illustrated in FIG. 1. In addition, a tour guide 110, 120 may want to recall all of his/her group members 111, 121, however, it would not be easy to call all of them in such a broad area.

The guiding services provided in an ordinary exhibition environment may be categorized into three types: manpower, audio and handset-based. The manpower method is getting rare because it takes extra human resources to provide the guiding services. The audio method is currently the most popular way for providing guiding services. When a visitor approaches to an object, he/she can request an introduction audio of the object. The handset-based method is getting more and more popular to provide guiding services by using PDAs with wireless network technology. A wireless handheld device must be carried by the visitor, so that the visitor may connect to the service interface provided by the exhibition environment via the wireless network and get the guiding information. However, the guiding services provided by the above three methods are mostly limited to providing the information of the objects being visited, without the directions for finding tour guides or group members. The guiding devices used in such environments are mostly for giving directions of emergency exits. The guiding devices and the guiding directions are often fixed.

The wireless sensor network was an idea first proposed in a research project held by Prof. David Culler, UC Berkeley, called the “Smart Dust”. In a wireless sensor network, sensor nodes are scattered intensively in an area being monitored. Each sensor nods detects certain environmental parameters, such as the temperature, moisture, pressure and sound, according to its specific requirement. And it may further transmit the collected information to a specific data collecting equipment utilizing wireless transmission technologies for further analysis or provides reactions accordingly.

### SUMMARY OF THE INVENTION

It is one object of the present invention for providing a guiding system which is capable of providing guiding services to a plurality of group members of at least one group and a leader thereof. The guiding system comprises: a sensor network having plural sensor nodes, the sensor nodes are capable of communicating with one another; a plurality of guiding directors, which are used for displaying guiding information; and at least one leader device, which is carried by the leader and capable of transmitting leader constructions to be detected by the sensor nodes in order to track the position of the leader. The sensor network is capable of receiving a trigger event to trigger a guiding mechanism and providing guiding services accordingly.

It is another object of the present invention to provide a guiding method which is capable of providing guiding services to a plurality of group members and group leaders. The method comprises the following steps: detecting a leader device and tracking the position of the leader; maintaining the status of the sensor nodes according to the position of the leader; detecting trigger events and judging the types of the trigger events; and activating a guiding mechanism to provide the guiding services by the guiding directors.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a sketch map of an exhibition environment;

FIG. 2 is a diagram of system structure according to one embodiment of the present invention;

FIG. 3 is a diagram of system deployment according to one embodiment of the present invention;

FIG. 4 is a block diagram of the leader device designed according to one embodiment of the present invention;

FIG. 5 illustrates the mapping information between group members and the RFIDs according to one embodiment of the present invention;

FIG. 6 is a flowchart for maintaining the status of the sensor network according to one embodiment of the present invention;

FIG. 7A is a diagram illustrating the initialization of the sensor network according to one embodiment of the present invention;

FIG. 7B is a diagram illustrating the updating process of the sensor network according to one embodiment of the present invention;

FIG. 8 is a flowchart according to one embodiment of the present invention;

FIG. 9 is a diagram illustrating the leader discovery process according to one embodiment of the present invention;

FIG. 10 is a diagram illustrating the member regrouping process according to one embodiment of the present invention.

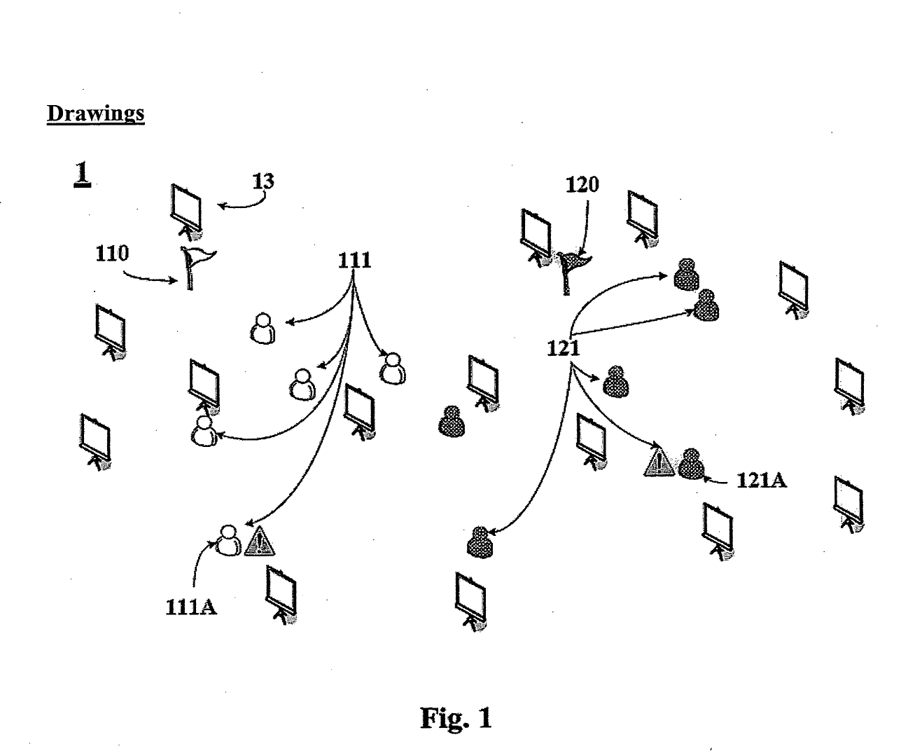

### DETAILED DESCRIPTION OF THE PREFERRED EMBODIMENTS

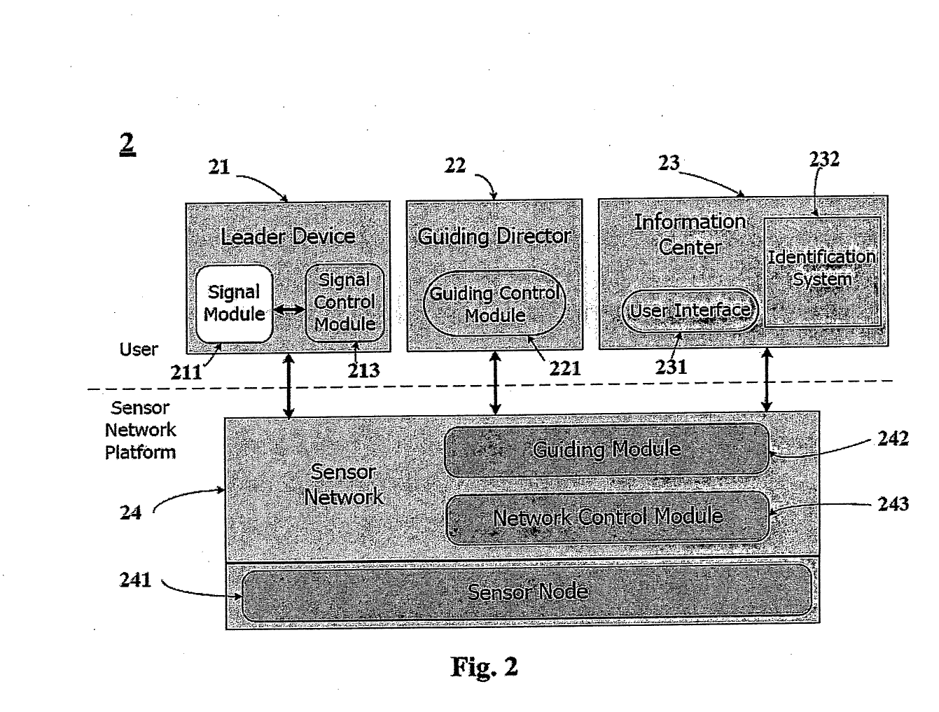

Please refer to FIG. 2, which illustrates the system structure 2 according to one embodiment of the present invention, including a leader device 21, a sensor network 24, a guiding director 22 and an information center 23. Because we want to know the position of the leader 110, 120, the leader 110, 120 must carry some devices to communicate with the sensor network 24, and that is the role played by the leader device 21. In addition to telling the sensor network 24 the location of the leader 110, 120, the leader device 32 may further activate other services of the sensor network 24, so it is actually a multifunctional device. In order to provide guiding service with the sensor network 24, the guiding director 22 is combined with the sensor node 241 of the sensor network 24 in this present invention, such that the guiding information, such as identities of the group and directions, may be provided. The group members 111, 112 may easily recognize and read the directions, and may thus easily be guided. The information center 23 has two major functions. First, it collects and updates the position information of each group leader 110, 120 in the sensor network environment via the sensor network 24. Second, it has the function of group member recognition such that the group members 111, 121 only need to input their identities into the information center 23, then they may have the position information of their leader 110, 120 and summit a guiding request. Inputting their identities may be in a way of carrying a RFID tag or an object containing that tag, such as the Easy Card or the IC card, to the information center to be read. The sensor network 24 is responsible for managing the information in every sensor node 241, receiving information transmitted from the leader device 21 and the information center 23, and delivering the information that is displayed on the guiding director 22 for guiding the group members 111, 121 to find their leader 110, 120.

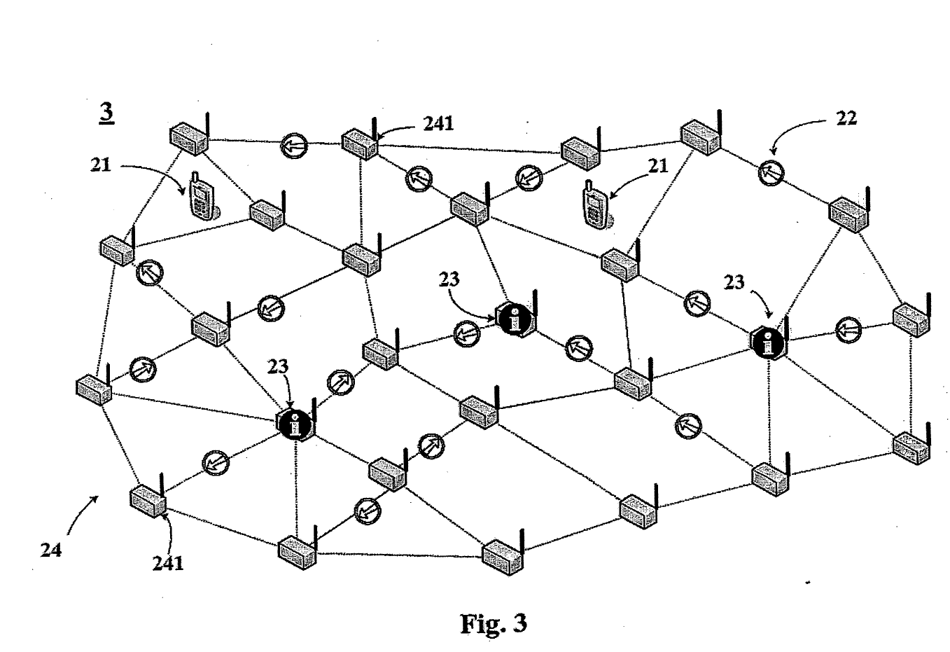

Please refer to FIG. 3, which is a diagram of system deployment according to one embodiment of the present invention. In this figure, one may see that many sensor nodes 241 are deployed in the passages of the exhibition environment. The sensor nodes 241 may communicate with one another to form a sensor network 24. Between the sensor nodes 241, several guiding directors 22 are disposed for providing guiding related information. In the sensor network 24, several information centers 23 are disposed at different positions. The leader devices 21 are carried by the leaders 110, 120 of each group such that the leader devices 21 may communicate with the sensor network 24 and the sensor network 24 may track the leaders 110, 120.

The following paragraphs are going to explain the functionalities of each parts of the system structure 2 in detail.

Leader Device 21

For tracking the positions of the leaders 110, 120 of each group in the exhibition environment, the most strait-forward way is making the leaders 110, 120 carry sensor nodes 241. And thus by transmitting signal to other sensor nodes 241 periodically, the latest position of each leader 110, 120 may be decided. However, the conventional sensor nodes are costly, at about $500. It may not be practical to use the sensor nodes as a tracking device massively and broadly in the actual practices. In order to lower the cost, a low cost leader device 21 is designed in this invention for tracking the leaders 110, 120. According to one embodiment of the present invention, acoustic signals are utilized to replace the conventional radio signals for tracking the leaders 110, 120 in the sensor network 21. A leader device 21 capable of producing a specific sound signal pattern is designed in the invention, such that the sensor nodes 241 may recognize different leaders 110, 120 accordingly. More specifically, the leader device 21 is capable of producing a sound signal with a frequency of approximately 4 KHz. The sound signal pattern of the sound signal may be adjusted dynamically, for emulating digital signals with analog signals, so as to transmit the identities (numbers) of the leaders.

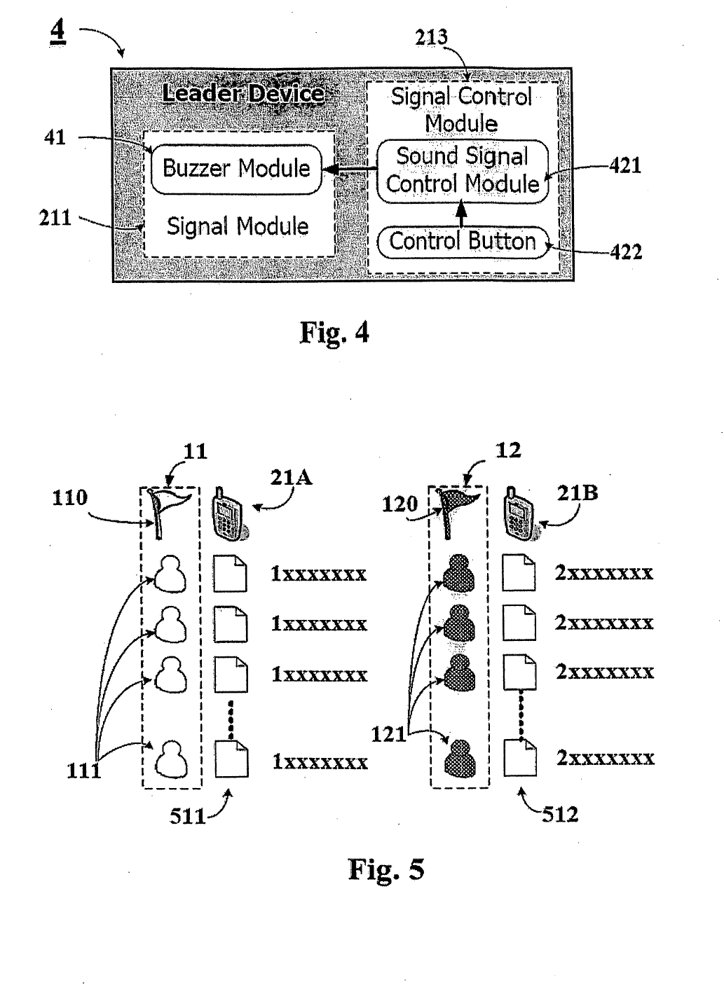

Please refer to FIG. 4, which is a block diagram of the leader device 4 designed according to one embodiment of the present invention. The leader device 4 comprises a buzzer module 41 and a signal control module 213. The signal control module 213 comprises a sound signal control module 421 and a control button 422. The buzzer module 41 is capable of producing a sound with a frequency of approximately 4 KHz. The sound signal control module 421 is a circuit for controlling the sound pattern. More specifically, it is able to control the time interval and the length of the sound being transmitted. In this embodiment of the present invention, the leader device 42 produces the leader signal with an interval of T seconds. The present and absence of the sound is used to emulate digital signals. That is, with a digit “1”, the 4 KHz sound is produced. On the other hand, with a digit “0”, no sound will be produced. The intervals between any 2 digits of the leader signal may be set as t seconds. People with ordinary skills in the art of this invention should be able to utilize such principle for designing appropriate signal formats for transmitting information. When a sensor node 241 detects the leader signals, a mechanism for recognizing the leader ID will be activated accordingly.

Information Center 23

The information center 23 is composed of a sensor node 241 of the sensor network 24, a user interface 231 and an identification system 232. It has two major functions. Firstly, it collects and updates the position information of each leader 110, 120 in the sensor network environment via the sensor network 24. Secondly, it has the function of group member recognition such that the group members only need to input their identities into the information center 23, they may get the position information of their leader 110, 120 automatically. In addition, by summiting a guiding request, the information center 23 may provide the guiding service for leading the group members to their leaders 110, 120.

For a more convenient tour, each group member only needs to carry a ticket for visiting. According to one embodiment of this invention, the identification system 232 of the information center 23 may be implemented with a radio frequency identification system (RFID). Because the rapid development of the RFID technology, the size of the RFID Tag is small and the price is low, which is quite suitable for massive reproduction. The RFID system may be, for example, the MPR-1230 series products manufactured by the AWID Corporation. FIG. 5 illustrates the mapping information between group members and the RFID tags according to one embodiment of the present invention. Through such arrangement, the tickets may be combined with the RFID tags 511, 512 for the group members 111, 121 to carry. While selling the tickets, the mapping information between each tags 511, 512 and groups 11, 12 may be established by the RFID system. It may further be dynamically adjusted according to the actual situation. Through reading the information on the tags 511, 512, the information center 23 may know which group 11, 12 bought this ticket, and may therefore know which group 11, 12 the group members 111, 121 belong to. The information centers 23 may be disposed at eye-catching spots in the exhibition environment. As long as the group members need to get the information about their leaders 110, 120, they only need to place their tickets near the RFID reader of the identification system 232 of the information center 23, and the user interface 231 of the information center 23 will display the positions of their leader 110, 120 and may further provide guiding services.

Guiding Director 22

The exhibition environments are usually broad and wide, and lots of people may come in and go out. In such kind of environment, it is not easy to find one person or a group of people. If using the man power to look for a specific person, it would be very time consuming. If using the broadcast system in a museum to find a person, other visitors may be affected. Therefore, it would be a very convenient way to find a specific person using signs that display guiding information. According to one embodiment of this invention, the sensor nodes 241 of the sensor network 24 are combined with the guiding indicators 22, such that the sensor nodes 241 may display information via the guiding directors 22. The guiding directors 22 may be implemented with LED arrays. According to this embodiment, a sensor node 241 is coupled to a LED control module of the LED array by a signal line. The signal line makes it possible for the sensor node 241 to transmit information that is needed to be displayed to the LED control module, and such the information displayed on the LED array may be controlled. When the sensor node 241 receives a leader discovering request or a member regrouping request, a signal may be transmitted to the LED control module via the signal line after the information processing of the sensor network 24. After interpreting the signal by the LED control module, the LED array displays the signs accordingly. For easier recognition of the signs for the group members 111, 121, LED arrays may use different color, such as green and red, for representing different guiding mechanisms. For example, according to one embodiment of the present invention, red color will be used by the LED arrays while the leader discovering mechanism is activated. And on the other hand, green color will be used by the LED arrays while the member regrouping mechanism is activated. As a result, group members 110, 120 not looking for their leaders 110, 120 may ignore LED arrays directly while red color is displayed, without misunderstanding that the group leaders 110, 120 are regrouping all the members. In addition, a group ID along with a guiding direction may be used as a display pattern, that is, after a group ID is displayed, the next thing appears on the LED array is the guiding direction. The time interval between each piece of information may be adjusted according to the requirements.

Sensor Network 24

The sensor network 24 is composed of a plurality of sensor nodes 241, for managing the information flow of the sensor nodes 241. The sensor network comprises a network control module 243 and a guiding module 242. The sensor node 241 capable of detecting acoustic signals may be implemented with, for example, the MPR2400CA radio platform in cooperated with a MTS300CA sensor board, developed by UC Berkeley. When the sensor node 241 detects a 4 KHz sound, a corresponding signal may be produced. By the signal, one may know that whether the sensor node 241 detects the presence of the leader device 21. In the design of the MICA sensor node 241, the sound is picked up by a microphone, and then passed through a pre-amplifier and fed to two different paths. One is directed to an A/D converter directly and stored in a memory for further analysis. The other is directed to an active filter for filtering required frequency of the sound signal, and then transmitting to an acoustic detector for a judgment. If the signal is at the required frequency (4 KHz˜5 KHz), a high signal will be replied. And if not, a low signal will be replied.

Network Control Module 243

The network control module 243 is responsible for maintaining the network status of the sensor network 24, such that the guiding module 242 may activate corresponding services while triggered by an event. When a service or event is taken place, the whole sensor network 24 must be maintained at the latest status and thereafter, the corresponding responds may be made. Therefore, when a leader 110, 120 first appears in the sensor network 24, an initialization mechanism will be activated for informing the whole sensor network 24 the position of the leader 110, 120 and updating respective information anytime.

In the application of the sensor network 24, the most important job is to track the current position of each leader 110, 120 and to let all the sensor nodes 241 know how to find the leader 110, 120 via the information exchange of the sensor network 24. According to one embodiment of the present invention, the idea of potential value is utilized to adjust the potential value of every sensor node 241 of the sensor network 24 and the guiding directions. The guiding direction points from the sensor node 241 with higher potential value to the sensor node 241 with lower potential value. And because the leaders 110, 120 are not likely to stay at one sensor node 241 for ever, they may move to different locations as time goes by. And thus it is necessary to adjust the potential value of the sensor nodes 241 according to the latest position of the leaders 110, 120.

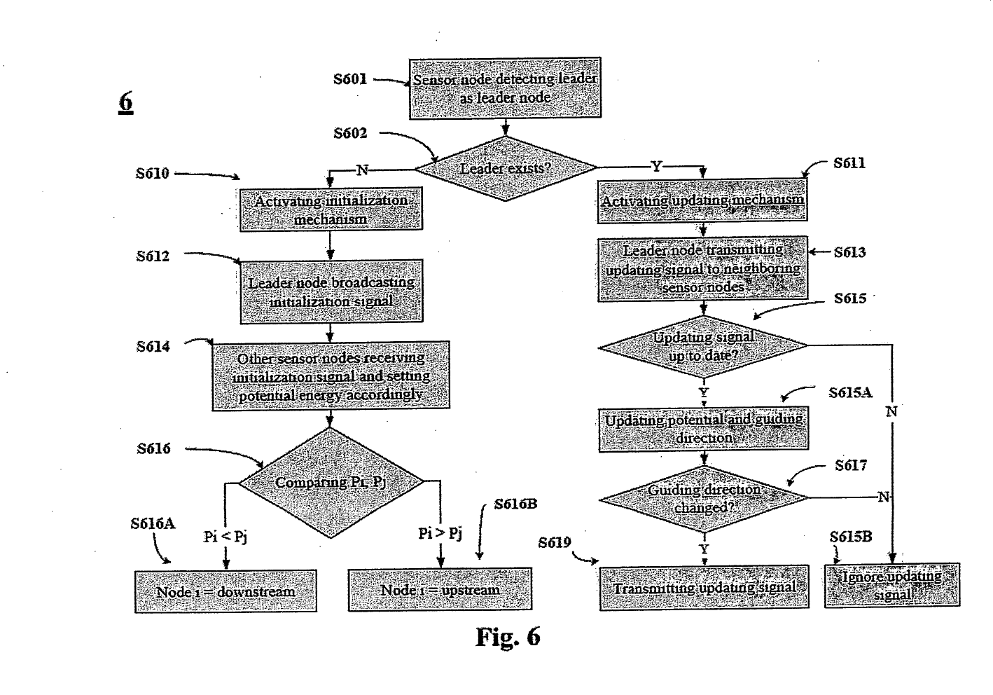

Please refer to FIG. 6, which is a flowchart for maintaining the status of the sensor network according to one embodiment of the present invention. As shown, when a sensor node of the sensor network 24 detects the appearance of a leader ID S601, the sensor network 24 must decide whether the leader ID has already existed S602. If the detected leader ID is a new leader ID, it means that a new leader is appearing and the initialization mechanism of the sensor network must be activated S610. If the detected leader ID is an existed leader ID, it means that it is an existing leader 110, 120 moving around the sensor network 24 and the mechanism of network maintenance must be activated S611. The following will explain the two kinds of scenario.

Scenario 1: Initialization Mechanism of the Sensor Network

The purpose of the initialization mechanism is that when a new leader 110, 120 appears, every sensor node 241 must be given a potential value accordingly. After the initialization process, every sensor node 241 will record information of itself and every leader 110, 120, including leader ID, sender ID, potential value and timestamp. The sensor node 241 which detects the leaders 110, 120 is called a leader node.

The leader node broadcasts an initialization signal S612 at the beginning of this stage. The initialization signal comprises five parts, they are: leader ID, sender ID, potential value, sensor node 241 ID and the timestamp. It should be noticed that the leader ID represents the identity of each leader 110, 120; sender ID represents the identity of the leader node; sensor node ID represents the identity of the sensor node which receives the initialization signal; and the timestamp is a reference value for maintaining the potential value of the whole sensor network 24.

The broadcasted initialization signal will be received by the other sensor nodes. The other sensor nodes then decide their potential value according to the relative position or rank to the leader node S614. For example, the potential value of the earliest transmitted initialization signal may be set to 1, and the potential value of the leader node i may be the lowest, i.e. 0. After the rest of the sensor nodes receive the signal, they may compare the potential value of every initialization signal with the same leader ID and pick and record the lowest value as their potential value. And then they may add 1 to the potential value of the signal and forward it out. And meanwhile, a neighboring table is maintained by every sensor node 241 for recording information of the neighboring sensor nodes, including leader ID, sender ID, potential value, sensor node ID and guiding direction.

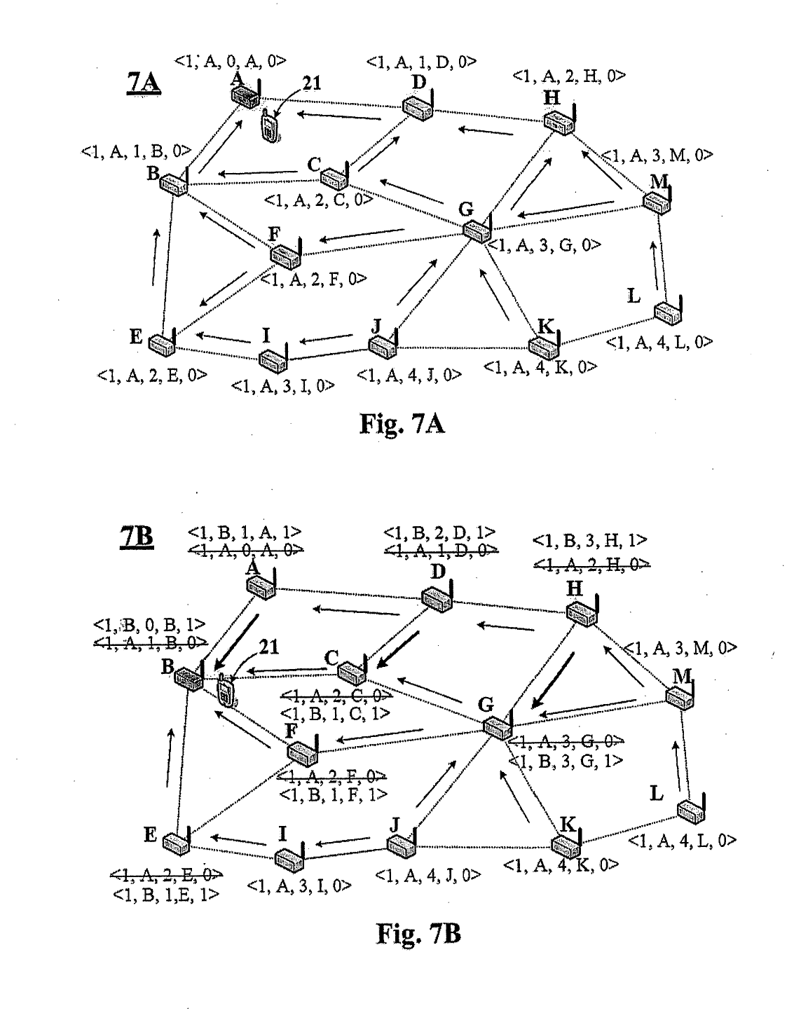

Then the neighboring sensor nodes will compare their potential value with each other and decide the guiding direction accordingly S616. The guiding direction may be categorized as the upstream direction and the downstream direction. For example, there are two sensor nodes i and j. If the potential value Pi of sensor node i is lower than the potential value Pj of sensor node j, then the sensor node i is a downstream sensor node and the sensor node j is an upstream sensor node S616A. On the other hand, if the potential value Pi of sensor node i is higher than the potential value Pj of sensor node j, then decide that the sensor node i is an upstream sensor node and the sensor node j is a downstream sensor node S616B. Therefore, after the initialization signal is broadcasted all over the sensor network 24, every sensor node 421 will be given a potential value and a guiding direction relative to a certain leader 110, 120. Please refer to FIG. 7A, which is a diagram illustrating the initialization of the sensor network according to one embodiment of the present invention. As shown in FIG. 7A, the sensor node A detects a new leader ID of the leader device 21 and becomes a leader node. It broadcasts an initialization signal and therefore gives every sensor nodes in the sensor network a potential value and a guiding direction.

Scenario 2: Updating Mechanism of the Sensor Network 24

If the detected leader ID exists in the neighboring table, this means that the leader 110, 120 has already appeared in the sensor network 24. Because the leader 110, 120 moves around the sensor network 24, his/her position has changed. Therefore the sensor node becomes a new leader node for detecting the leader ID, adjusts is records according to the leader ID and activates the updating mechanism to notify the sensor network that the leader 110, 120 has changed his/her position S611.

The new leader node transmits an update signal (or an update packet) to its neighboring sensor nodes S613. The update signal is composed of five parts; they are: leader ID, sender ID, potential value, sensor node ID and the timestamp. After the neighboring sensor nodes receive the update signal, they check the timestamp of the update signal for confirmation S615. If the update signal is up to date, then it updates its information record and the neighboring table accordingly S615A. If the update signal is out of date, it may ignore the update signal directly S615B.

The main point of the updating process is that the potential value and the guiding direction of the sensor nodes must be updated. However, a full scale updating of the sensor nodes 241 may result in excess data flow over the whole sensor network 24. Therefore, according to one embodiment of the present invention, a strategy of regional update may be utilized. After the sensor node 241 receives the update signal from the neighboring sensor node 241 and accomplishes information updating, it may further decide whether the guiding direction to that neighboring sensor node is changed S617. If the guiding direction to the neighboring sensor node 241 is changed, it forwards the update signal to its neighboring sensor nodes 241 for updating S619. If the guiding direction to the neighboring sensor node 241 is not changed, it may ignore the update signal directly S615B. That is, according to this embodiment of the present invention, the variation of the guiding direction between sensor nodes may be utilized for deciding whether to forward the update signal, and such, the regional updating strategy may be accomplished. Please refer to FIG. 7B, which is a diagram illustrating the updating process of the sensor network according to one embodiment of the present invention. As shown in FIG. 7B, when the leader device moves from sensor node A to sensor node B, in addition to the direct neighboring sensor nodes A, C, E and F of the new leader node B that receive the update signal, only part of the rest of the neighboring sensor nodes D, G and H, with changed guiding direction, may receive the update signal, and the rest of the sensor nodes of the sensor network do not need to be updated.

While changing the potential value of the sensor nodes, the local minimum problem might occur which may lead the guiding direction to a dead-end. There are two reasons that may cause local minimum node: 1. the failure of the link between the sensor nodes 241; 2. the movement of the leaders 110, 120. The basic issue behind these reasons is that the sensor node 241 has no downstream node for leading out its potential value while it itself is not a leader node. According to one embodiment of the present invention, the method of link reversal is utilized to solve this problem. When a sensor node 241 finds itself a local minimum sensor node, it elevates its potential value to a value that is greater to any value stored in the neighboring table, and then tells this information to its neighboring sensor nodes. With such measure, the original guiding direction is changed and this sensor node 241 is no longer a local minimum sensor node. However, such change may cause other sensor nodes become a local minimum sensor node, so it may be necessary to do the link reversal recursively and eventually potential value of the sensor nodes 241 of the sensor network 24 will get to an equilibrium point. To find the failure of the link, according to an embodiment of this invention, a hello packer is broadcasted to neighboring sensor nodes periodically and thus making sure that the neighboring sensor nodes are all alive. When a leader node lose the leader signal of the leader 110, 120, it proceeds a self-checking that whether itself becoming a local minimum sensor node. If it is, the link reversal mechanism will be activated.

In addition, the network control module 243 is also in charge of receiving messages transmitting from the leader device 21 and the information center 23, and sending the information needed to be display to the guiding indicator 22. While a group member 111, 121 triggered the guiding service at the information center 23, the sensor network will find the location of his/her leader 110, 120 and display the guiding route. On the other hand, when a leader 110, 120 wants to gather his/her group members 111, 121, he/she only needs to send a request to the sensor network 24 and all the routes leading to the leader 110, 120 will be displayed by the guiding indicator 22 in the sensor network 24 which helps the group members 111, 121 find their leader 110, 120.

Guiding Module 242

The guiding module 242 is responsible to lead the group members 111, 121 to their leaders 110, 120. According to one embodiment of the present invention, there may be two kinds of guiding mechanisms: the leader discovering mechanism and the member regrouping mechanism. For the leader discovering mechanism, when the information center 23 is triggered by the leader discovering event from the group member 111, 121, the discovering message will be transmitted to the sensor network 24. The sensor network 24 then reports the location of the specified leader 110, 120 to the information center 23 and guides the group member 110, 120 to his/her leader 110, 120. For the member regrouping mechanism, when the leader 110, 120 summits a request for regrouping his/her group members 111, 121, the whole sensor network 24 will make a response. The guiding directors 22 will show all the paths leading to the leader 110, 120 and the group members 111, 121 may follow these paths and find their leaders 110, 120.

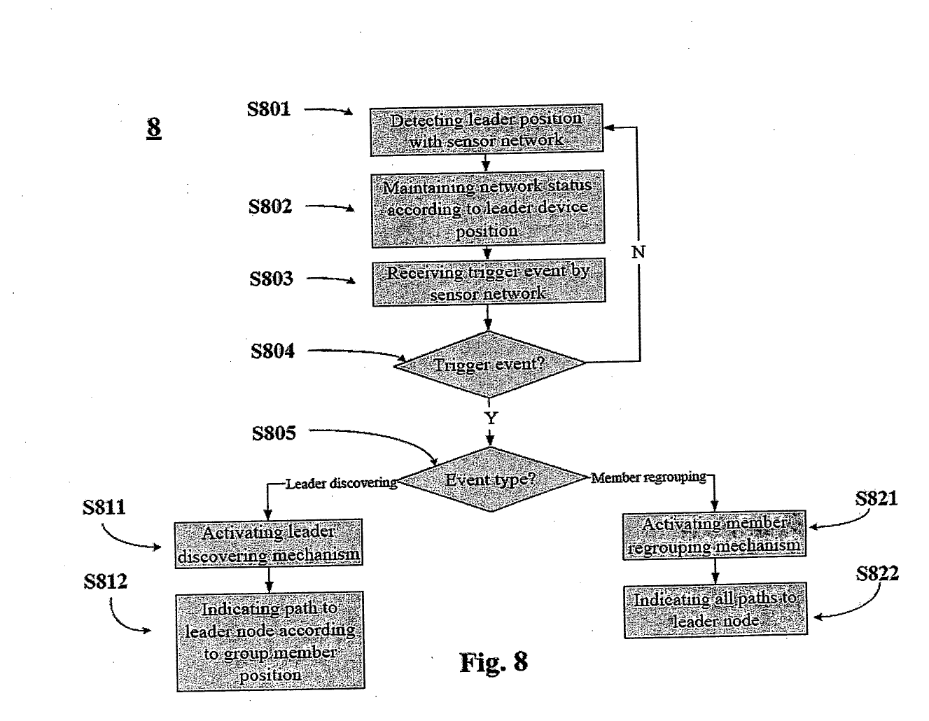

Please refer to FIG. 8, which is a flowchart according to one embodiment of the present invention. According to this embodiment, firstly, the sensor nodes of the sensor network detect the leader device for finding the position of each leader 110, 120 of the groups in the exhibition environment S801. Secondly, the status of the sensor nodes of the sensor network is maintained by an initialization mechanism or an updating mechanism according to the leader ID of the leader device S802. Then the sensor network gets ready to receive a trigger event by the sensor nodes S803 and deciding whether a trigger event has happened S804. If not, the sensor network continues to detect the leader device. If a trigger event is received, the type of trigger event is decided S805. If a leader discovering event is received, the mechanism of leader discovering will be activated S811 and guiding the group member to his/her leader by display a path to the leader with the guiding directors according to the position of the member S812. If a member regrouping event is received, the mechanism of member regrouping will be activated S821 and displaying all paths leading to the leader with the guiding directors according to the position of the member S822. The following paragraphs will explain leader discovering event and member regrouping event in detail.

Leader Discovering Event

When visiting a conventional museum or an art museum, it is possible that some group members 111, 121 may get lost and need to find their leaders 110, 120, or some other information. Because the group members 111, 121 raise the request in this kind of event, it is called a member triggered event. The following will describe how to activate the leader discovering mechanism for finding the leader 110, 120 in the sensor network 24 in the member triggered event of leader discovering, and give every sensor node 241 the correct guiding direction for providing service to the group member 111, 121.

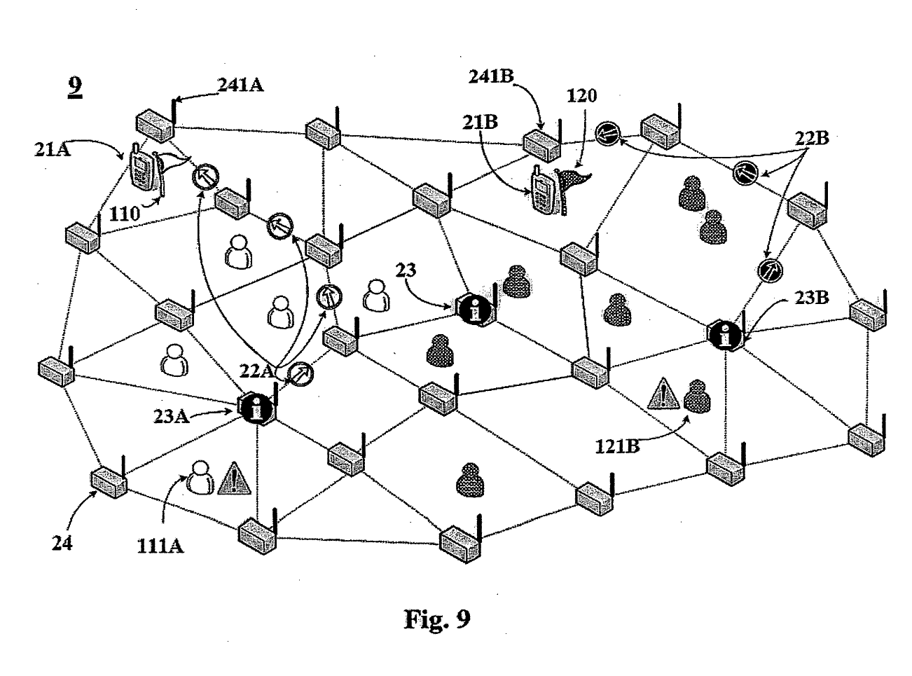

Please refer to FIG. 9, which is a diagram illustrating the leader discovering process according to one embodiment of the present invention. As shown in this figure, a group member 111A of a group may get lost and require the guiding service. The lost group member 111A may summit a guiding service request to the sensor network 24. When anyone of the sensor nodes 241 receives this event, it becomes a top node and sends a leader discovering signal. According to this embodiment of the present invention, the lost group member 111A may summit the leader discovering request at the nearest information center 23A for the guiding service. After the information center 23A receives the trigger event from the group member 111A, it passes the information to the sensor network 24 and then the sensor network 24 reports the position of the leader 110 of the lost group member 111A to the information center 23A and guides the lost group member 111A to the leader 110. According to this embodiment, the shortest route may be the strategy for finding the path from the top node, i.e. the information center 23A, to the leader node, i.e. the sensor node 241A. Because every sensor node 241 has a neighboring table, by table looking up, it is possible to find out which downstream sensor node is nearest to the leader 110, 120. Therefore, the path and the direction from the top node to the leader node may be found. And by the guiding directors 22A on the path, the group member 111A may be lead to his/her leader 110. Similarly, the lost group member 121 B may summit the leader discovering request at the nearest information center 23B for the guiding service. After the information center 23B receives the trigger event from the group member 121B, it passes the information to the sensor network 24 and then the sensor network 24 reports the position of the leader 110 of the lost group member 121B to the information center 23B and guides the lost group member 121B to the leader 110. According to this embodiment, the shortest route may be the strategy for finding the path from the top node, i.e. the information center 23B, to the leader node, i.e. the sensor node 241B. By table looking up, it is possible to find which downstream sensor node is nearest to the leader 110, 120. Therefore, the path and the direction from the top node to the leader node may be found. And by the guiding directors 22B on the path, the group member 121B may be lead to his/her leader 120.

Member Regrouping Event

While visiting a conventional museum or an art museum, the group members 111, 121 may be too concentrated on the object in front of them and thus ignore the time limit. In addition, leaders 110, 120 may need to gather all their group members 111, 121 for some reasons. Under such kind of situation, the leaders 110, 120 need the whole senor network to activate the member regrouping mechanism for gathering their group members 111, 121, which is called a leader triggered event.

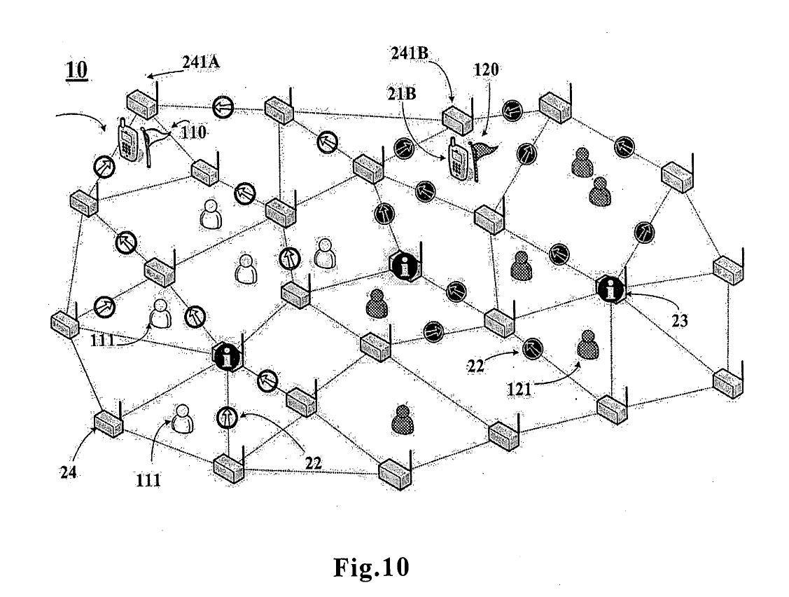

Please refer to FIG. 10, which is a diagram illustrating the member regrouping process according to one embodiment of the present invention. As shown in this figure, there are two groups of people 111, 121 scattering and moving freely in the sensor network 24. According to this embodiment of the present invention, if one of the leader 110 needs to regroup his/her group members 111, the leader 110 may summit a member regrouping request to the sensor network 24 by the leader device 21A carrying with him. When the sensor node closest to the leader 110, i.e. the leader node 241A, is trigger by this event, the member regrouping mechanism will be activated. Then, the leader note 241A may broadcast a member regrouping signal all over the sensor network 24. When the other sensor nodes 241 receive the member regrouping signal, they may be able to know which leader node requests to display the guiding information for regrouping group members. And then they look up the neighboring tables for finding the downstream sensor node nearest to the leader node 241A as the guiding direction. After every sensor node 241 receives the member regrouping signal, all paths leading to the leader node 241A in the sensor network 24, i.e. the paths leading to the leader, may be found. Then, by the guiding indicators 22 disposed on the paths, the group ID and the guiding direction may be displayed. The group members 111 of this group may follow the directions giving by the guiding indicators 22 and regroup at the leader's site. Similarly, if the other leader 120 needs to regroup his/her group members 121, the leader 120 may summit a member regrouping request to the sensor network 24 by the leader device 21B carrying with him. When the sensor node closest to the leader 120, i.e. the leader node 241B, is trigger by this event, the member regrouping mechanism will be activated. Then, the leader note 241B may broadcast a member regrouping signal all over the sensor network 24. When the other sensor nodes 241 receive the member regrouping signal, they may know which leader node requests to display the guiding information for regrouping group members. And then they look up the neighboring tables for finding the downstream sensor node nearest to the leader node 241B as the guiding direction. After every sensor node 241 receives the member regrouping signal, all paths leading to the leader node 241B in the sensor network 24, i.e. the paths leading to the leader, may be found. Then, by the guiding indicators 22 disposed on the paths, the group ID and the guiding direction may be displayed. The group members 121 of this group may follow the directions giving by the guiding indicators 22 and regroup at the leader's site. If the two leaders 110, 120 request to regroup their group members 111, 121 at the same time, the guiding indicators may display different colors or ways to distinguish different paths leading to different leaders 110, 120 for the group members 111, 121.

In summary, by utilizing wireless sensor network technology in this invention, a method of group guiding service using wireless sensor network and a system using the same are disclosed for satisfying the guiding services required by exhibition environments. According to the present invention, the wireless sensor network 24 may be used to track the position of the leaders 110, 120 and provide leader information and guiding services to the group members 111, 121. In the system and method of this invention, in addition to monitoring the environment, the sensor network 24 tracks the leaders 110, 120 of each group by detecting the leader devices 21. By the wireless transmission technology, the whole sensor network 24 may know the current position of each leader 110, 120. Besides, the present invention combines the sensor network 24 with several multifunctional guiding directors 22 for displaying environment information and guiding directions. For an easier and cozy tour for the group members 111, 121, the RFID technology is utilized in this invention. The group members 111, 121 only need to carry tickets which are combined with RFID tags and then may find their leaders 110, 120 easily. Similarly, with the leader devices developed in this invention, the leaders 110, 120 may regroup their group members 111, 121 easily.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A guiding system for providing guiding services to a plurality of group members of at least one group and a leader thereof, the guiding system comprising:
a sensor network having a plurality of sensor nodes capable of communicating with one another;
a plurality of guiding directors, for displaying guiding information; and
at least one leader device carried by the leader, for transmitting a leader signal to be detected by the sensor nodes such that the sensor network is able to track a position of the leader device according to the leader signal;
wherein the sensor network is capable of receiving a trigger event, triggering a guiding mechanism accordingly, and providing guiding service by the plurality of guiding directors.

2. The guiding system of claim 1, wherein the sensor network further comprises a network control module, for maintaining a network status of the sensor network according to the position of the leader device.

3. The guiding system of claim 2, wherein the network status comprises at least one potential value of each of the plurality of sensor nodes.

4. The guiding system of claim 3, wherein the network status further comprises a guiding direction between one of the plurality of sensor nodes and one neighboring sensor node thereof, defined according to the potential values.

5. The guiding system of claim 2, wherein an initialization mechanism and an updating mechanism are utilized for maintaining the network status of the sensor network while the leader device is detected, and if the leader device appears in the sensor network for a first time, the initialization mechanism is activated, if not, the updating mechanism is activated.

6. The guiding system of claim 5, wherein the initialization mechanism defines a sensor node which detects the leader device as a leader node and makes the leader node broadcast an initialization signal to the rest of the plurality of the sensor nodes.

7. The guiding system of claim 6, wherein the initialization mechanism further sets a base potential value to the leader node and sets potential values for the rest of the plurality of sensor nodes, in which sensor nodes those are farther from the leader node are set to have potential values with more differences from the base potential value and vise versa, according to the initialization signal.

8. The guiding system of claim 7, wherein the network status further comprises a guiding direction between one of the plurality of sensor nodes and one neighboring sensor node thereof, defined according to the potential values.

9. The guiding system of claim 5, wherein the updating mechanism is a regional updating mechanism.

10. The guiding system of claim 5, wherein the updating mechanism defines a sensor node which detects the leader device as a leader node, and sets a base potential value to the leader node, makes an updating signal transmitted from the leader node to neighboring sensor nodes thereof, and makes the neighboring sensor nodes thereof those receive the updating signal adjust relative potential values and guiding directions accordingly.

11. The guiding system of claim 10, wherein the neighboring sensor nodes check whether the updating signal is up to date, if not, ignore the updating signal.

12. The guiding system of claim 10, wherein the neighboring sensor nodes check whether the guiding directions are changed by the updating signal, if not, stop forwarding the updating signal to a next neighboring sensor node.

13. The guiding system of claim 1, wherein the sensor network further comprises a guiding module, for deciding the type of the trigger event and initiating a corresponding guiding mechanism.

14. The guiding system of claim 13, wherein the trigger event comprises a leader discovering event and the corresponding guiding mechanism comprises a leader discovering mechanism.

15. The guiding system of claim 14, wherein the leader discovering event is triggered by one of the plurality of group members at one of the plurality of sensor nodes.

16. The guiding system of claim 15, wherein the leader discovering mechanism uses the plurality of guiding directors indicating a path, according to the position of the group member who triggered the leader discovering event, to the leader thereof.

17. The guiding system of claim 16, wherein the path is decided according to a shortest route strategy.

18. The guiding system of claim 13, wherein the trigger event comprises a member regrouping event and the corresponding guiding mechanism comprises a member regrouping mechanism.

19. The guiding system of claim 18, wherein the member regrouping event is triggered by the leader using the leader device at one of the plurality of sensor nodes.

20. The guiding system of claim 19, wherein the member regrouping mechanism uses the plurality of guiding directors indicating at least one path to the leader who triggered the member regrouping event, according to the position thereof.

21. The guiding system of claim 20 where all paths to the leader are indicated.

22. The guiding system of claim 1, wherein at least one information center is included, for providing a user interface for the plurality of group members being able to communicate with the sensor network.

23. The guiding system of claim 22, wherein the information center further comprises an identification system, for identifying the group of the plurality of group members.

24. The guiding system of claim 23, wherein the identification system is implemented with a RFID system, for identifying RFID tags carried by the plurality of group members and then identifying the group of the plurality of group members.

25. The guiding system of claim 23, wherein the plurality of group members are able to obtain information of the position of their leader at the information center.

26. The guiding system of claim 23, wherein the plurality of group members are able to issue a leader discovering event at the information center.

27. The guiding system of claim 1, wherein the leader device comprises:
a signal module, for generating the leader signal; and
a signal control module, for controlling patterns of the leader signal.

28. The guiding system of claim 27, wherein the signal module comprises a buzzer module for generating the leader signal in acoustic form.

29. The guiding system of claim 28, wherein the frequency of the acoustic form of the leader signal is approximately 4 KHz.

30. The guiding system of claim 28, wherein the signal control module comprises a sound signal control module and a control button, for generating and adjusting the patterns of the leader signal according inputs of the control button.

31. The guiding system of claim 1, wherein each of the guiding directors couples to at least one of the plurality of sensor nodes.

32. The guiding system of claim 31, wherein the guiding director is implemented with a LED array and a LED control module, and the LED control module is capable of being controlled by the sensor node coupled thereto and controlling information displayed on the LED array accordingly.

33. The guiding system of claim 32, wherein the LED array is capable of displaying different colors for different guiding mechanisms.

34. A guiding method which is capable of providing guiding services to a plurality of group members of at least one group and a leader thereof, comprising steps of:
detecting a leader device, carried by the leader, with a sensor network, for tracking a position of the leader;
maintaining a status of the sensor network according to the position of the leader;
receiving a trigger event with the sensor network; and
providing the guiding service with a plurality of guiding directors by deciding a type of the trigger event and activating a guiding mechanism accordingly.

35. The guiding method of claim 34, wherein while the leader device is detected, check if the leader appears in the sensor network for a first time, if so, activating an initialization mechanism; if not, activating an updating mechanism.

36. The guiding method of claim 35, wherein the initialization mechanism comprises steps of:
setting a sensor node which detects the leader as a leader node in the sensor network, and setting a base potential value to the leader node;
making the leader node broadcast an initialization signal to the rest of the plurality of sensor nodes of the sensor network;
setting potential values for the rest of the plurality of sensor nodes, in which sensor nodes those are farther from the leader node are set to have potential values with more differences from the base potential value and vise versa, according to the initialization signal; and
defining a guiding direction between one of the plurality of sensor nodes and one neighboring sensor node thereof, according to the potential value.

37. The guiding method of claim 35, wherein the updating mechanism is a regional updating mechanism.

38. The guiding method of claim 35, wherein the updating mechanism comprises the steps of:
setting a sensor node of the sensor network which detects the leader as a leader node, and setting a base potential value to the leader node;
transmitting an updating signal by the leader node to neighboring sensor nodes thereof; and
updating potential values and guiding directions of the neighboring sensor nodes according to the updating signal.

39. The guiding method of claim 38, wherein the neighboring sensor nodes check whether the updating signal is up to date, if not, ignore the updating signal.

40. The guiding method of claim 38, wherein the neighboring sensor nodes check whether the guiding directions are changed by the updating signal, if not, stop forwarding the updating signal to a next neighboring sensor node.

41. The guiding method of claim 34, wherein the trigger event comprises a leader discovering event triggered by one of the plurality of group members, and the corresponding guiding mechanism comprises a leader discovering mechanism.

42. The guiding method of claim 41, wherein the leader discovering mechanism comprises a step of:
using the plurality of guiding directors indicating a path, starting from the sensor node accepted the leader discovering event to the leader of the group member.

43. The guiding method of claim 42, wherein the path is decided according to a shortest route strategy.

44. The guiding method of claim 34, wherein the trigger event comprises a member regrouping event triggered by the leader, and the corresponding guiding mechanism comprises a member regrouping mechanism.

45. The guiding method of claim 44, wherein the member regrouping event is triggered by the leader using the leader device at one of the plurality of sensor nodes.

46. The guiding method of claim 45, wherein the member regrouping mechanism comprises a step of:
indicating at least one path to the leader who triggered the member regrouping event with the plurality of guiding directors.

47. The guiding method of claim 46, wherein the indicating step indicates all paths to the leader who triggered the member regrouping event.
